(19) United States
(12) Patent Application Publication
(10) Pub. No.: US 2007/0182776 A1
(43) Pub. Date: Aug. 9, 2007

(54) OPTICAL SENSING EQUIPMENT

(76) Inventors: Bart Parish, Corinth, TX (US); Michael L. McCauley, Dallas, TX (US)

Correspondence Address: DUBOIS, BRYANT, CAMPBELL & SCHWARTZ, LLP, 700 LAVACA STREET, SUITE 1300, AUSTIN, TX, 78701, US

(21) Appl. No.: 11/620,273

(22) Filed: Jan. 5, 2007

Related U.S. Application Data
(60) Provisional application No. 60/771,327, filed on Feb. 8, 2006.

(51) Int. Cl. B41J 29/38

(52) U.S. Cl. 347/16

(57) ABSTRACT

Provided is a method comprising illuminating paper moving on a substantially vertical transport belt; sensing variations in reflectivity among the paper; comparing the variations in reflectivity to pre-selected acceptable reflectivity values, thus determining locations of acceptable paper on the transport belt; and rejecting paper based on the locations of acceptable paper. Also provided is a paper handling method comprising creating a negative pressure on the posterior side of a transport belt, the transport belt moving in a substantially vertical plane; passing the transport belt through a bin of paper, the paper removeably affixed to an anterior side of the transport belt by the negative pressure; and selectively detaching the paper from the transport belt by selectively injecting air through perforations in the transport belt, the injected air overcoming the negative pressure. A paper handling system is provided, the system comprising a continuous transport belt having perforations and moving in a substantially vertical plane; an apparatus for creating a negative pressure on the posterior side of the transport belt; a bin containing an assortment of paper at the base of the transport belt whereby the paper is removeably affixed to the anterior side of the transport belt by the negative pressure as the transport belt moves in a substantially vertical plane; and an array of valves positioned on the posterior side of the transport belt for selectively injecting air through the perforations in the transport belt depending on variations in reflectivity among the paper, thereby overcoming the negative pressure and causing the paper to detach from the transport belt.

### BACKGROUND OF THE INVENTION

The present invention relates to a system and method for sorting mass recyclables and more particularly to a system for sensing and sorting white paper from other materials or, conversely, other materials from white paper.

In light of the shortages of timber for paper manufacture and the expense of making paper from raw timber, it has been found desirable to recycle or reuse certain types of papers. To do so, it is necessary to separate paper by color. In the paper recycling industry, it has been the practice to sort papers manually using a horizontal conveyor to transport the paper. This is a time consuming and relatively expensive operation. The paper can only be sorted on a relatively small scale and the process is painstakingly slow. Thus, it is desirable to have an improved method and system capable of automatically sorting paper in the recycling process.

### BRIEF SUMMARY OF THE INVENTION

In various embodiments, a method is provided that comprises illuminating paper moving on a substantially vertical transport belt; sensing variations in reflectivity among the paper; comparing the variations in reflectivity to pre-selected acceptable reflectivity values, thus determining locations of acceptable paper on the transport belt; and rejecting paper not at the locations of acceptable paper. The method can further include generating a map depicting locations of paper on the transport belt, each location indicative of the reflectivity of the paper at the location.

In other embodiments, a paper handling method is provided that comprises creating a negative pressure on the posterior side of a transport belt, the transport belt moving in a substantially vertical plane; passing the transport belt through a bin of paper, the paper removeably affixed to an anterior side of the transport belt by the negative pressure; and selectively detaching the paper from the transport belt by selectively injecting air through perforations in the transport belt, the injected air overcoming the negative pressure.

In still other embodiments, a paper handling system is provided that comprises a continuous transport belt having perforations and moving in a substantially vertical plane; an apparatus for creating a negative pressure on the posterior side of the transport belt; a bin containing an assortment of paper at the base of the transport belt whereby the paper is removeably affixed to the anterior side of the transport belt by the negative pressure as the transport belt moves in a substantially vertical plane; and an array of valves positioned on the posterior side of the transport belt for selectively injecting air through the perforations in the transport belt depending on variations in reflectivity among the paper, thereby overcoming the negative pressure and causing the paper to detach from the transport belt.

### BRIEF DESCRIPTION OF THE DRAWINGS

In the following detailed description of embodiments of the invention, reference is made to the accompanying drawings, which form a part hereof, and in which is shown by way of illustration specific exemplary embodiments in which the invention may be practiced, and in which like numbers represent the same or similar elements and one or a plurality of such elements, as follows:

FIG. 1 is a flow diagram illustrating a method of sorting paper using optical sensing equipment in accordance with embodiments of the present invention.

FIG. 2 is a flow diagram illustrating a paper handling method in accordance with embodiments of the present invention.

FIG. 3 is a diagram of a paper handling system using optical sensing equipment in accordance with embodiments of the present invention.

FIG. 4 is another diagram of a paper handling system in accordance with embodiments of the present invention.

FIG. 5 is an alternative view of a paper handling system in accordance with embodiments of the present invention.

FIG. 6 is a diagram of electronics associated with sensing equipment in accordance with embodiments of the present invention.

### DETAILED DESCRIPTION

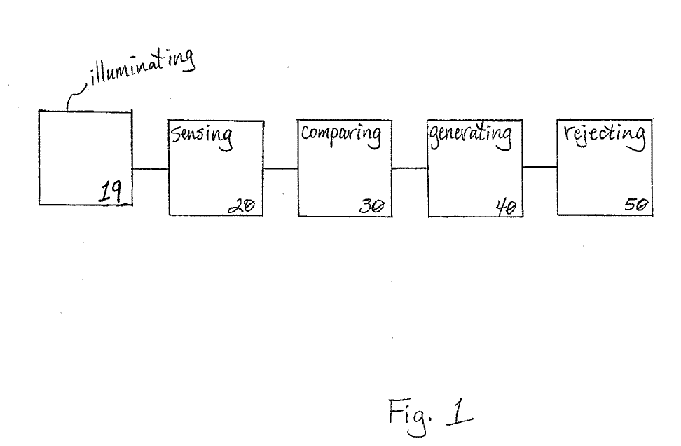

FIG. 1 is a flow chart illustrating a method of sorting paper using optical sensing equipment in accordance with embodiments of the present invention. The method comprises illuminating 19 paper on a moving transport belt; sensing 20 illumination levels among the paper; comparing 30 the illumination levels to pre-selected values for determining rejection; generating 40 a map representing acceptable illumination levels at locations on the map; and rejecting 50 paper based on the location of acceptable illumination levels on the map.

In various embodiments, illuminating 19 comprises exposing the paper on the transport belt to long wave ultraviolet light, visible light, infrared light, or combinations thereof. Sensing 20 illumination levels among the paper may be carried out in some embodiments by one or more sensing units. The sensing units can be any unit capable of detecting the reflectivity of paper, such as a single line pixel array sensing unit.

The detected illumination levels may be compared to pre-selected values for determining paper rejection using electronics as described in more detail below. Such pre-selected values may be varied depending on desired reflectivity among paper to be sorted. A grid of comparison values proportional to the illumination levels sensed from the transport belt is used by the electronics to generate a map. The map depicts the location of paper on the transport belt and identifies which papers have a reflectivity greater than the pre-selected value and which papers have a reflectivity less than the pre-selected value.

In several embodiments the map of illumination levels is used to retain or reject paper on the belt. The electronics and map synchronize the rejection method with the movement of paper on the transport belt.

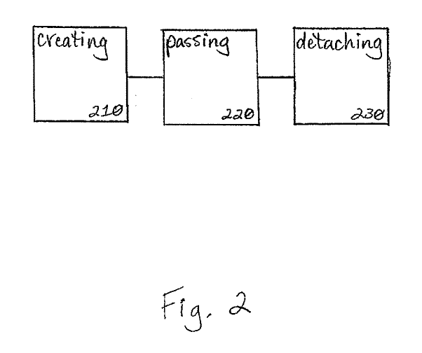

FIG. 2 is a flow chart representing a method of handling paper in accordance with embodiments of the present invention. In various embodiments, the method comprises creating 210 a negative pressure on the posterior side of a transport belt, the transport belt moving in a substantially vertical plane; passing 220 the transport belt through a bin of paper, the paper removeably affixed to the anterior side of the transport belt by the negative pressure; and selectively detaching 230 the paper from the transport belt by selectively injecting air through perforations in the transport belt, the injected air overcoming the negative pressure. In some alternative embodiments, selectively detaching 230 the paper may comprise neutralizing the vacuum by selectively actuating a valve, such as in an array of valves where the valve to be actuated is located in a position on the posterior side of the transport belt corresponding to the position of the paper to be detached, and neutralizing the vacuum thus releases the paper.

In various embodiments the methods illustrated in FIG. 1 and FIG. 2 may be combined. In some embodiments, passing 220 the transport belt through a bin of paper may be followed by leveling (not shown) the paper on the belt before illuminating 210 the paper.

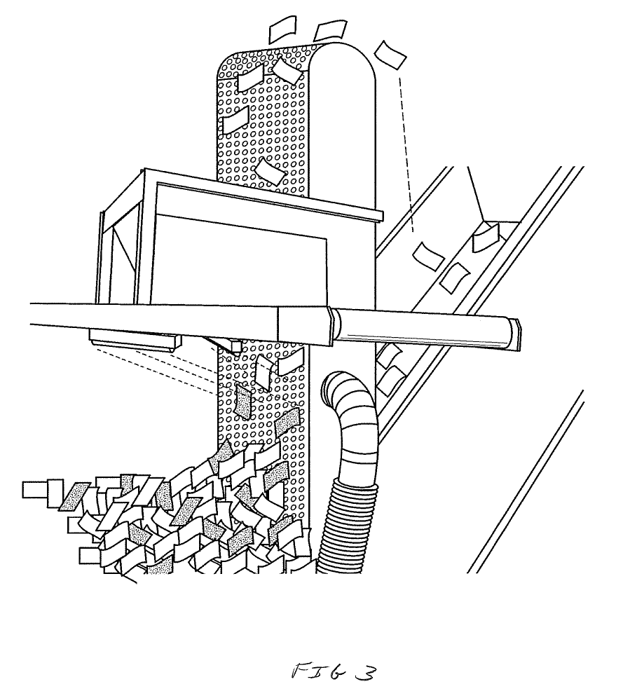

FIG. 3 introduces a paper handling system 300 comprising optical sensing equipment in accordance with embodiments of the invention. One or more lights 1 are located adjacent to the material transport belt 2. Note that the elements of the system are not to scale, but the representation of the elements is in an orientation substantially similar to that in which they would be observed during the normal operation of the invention, in other words upright, with paper flow progressing from bottom to top.

The belt 2 is perforated over its entire surface with an array of holes in a uniform grid. The array of holes may take on a number of configurations where features such as hole size, shape, and spacing are varied. Variables can be optimized for particular processing conditions, e.g.—materials, sorting environments, capacities, types of equipment, and the like. In one embodiment, the nominal hole spacing is two (2) inches, with holes of one and one quarter (1¼) inches.

The material transport frame 6 is hollow and is equipped with ducting connecting it to a centrifugal fan (off figure) or other device capable of generating a vacuum. The fan is arranged to produce a negative air pressure inside the frame 6 relative to atmospheric pressure. When the belt 2, moving, for example, on rollers built into the frame 6, is presented to a repository 8 of waste material (e.g.—mixed paper), the pressure differential draws paper to the belt 2 and holds it against the belt. Thus, the belt 2 passes through the paper and extracts the paper from the repository 8. The paper is carried vertically on the surface of the belt 2 by the action of the pressure differential holding the paper against the belt 2.

The flow of paper travels upward past a leveling arrangement (not shown). Depending on the character of the material in the repository 8 and the desired results, the leveling arrangement may consist of an array of roller(s), brush(es), and so on, selected to achieve the best leveling effect. Optimally, all material leaving the leveling arrangement is one layer thick, and is separated such that there is little if any piece to piece overlap.

The material captured on the transport belt 2 is a random sample of the mixed material/paper in the repository 33. Thus, the captured material can include a variety of different shades/colors. The instance depicted in FIG. 3 illustrates this with a mixture of light papers 42 and shaded papers 44 in the repository 33 that are also shown captured on the transport belt 2.

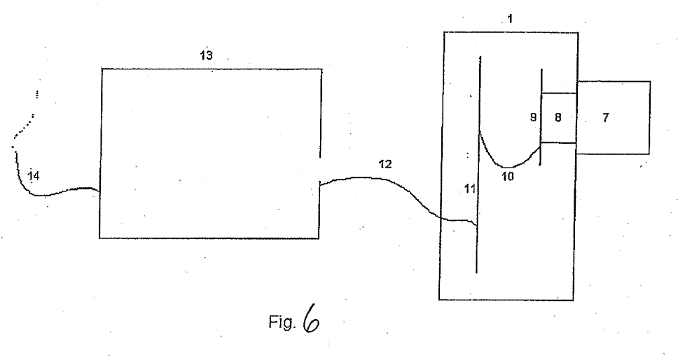

The material, thus captured and leveled, moves upward on the transport belt 2 to the inspection area. Lighting 3 may be fluorescent and/or incandescent lamps and is generally selected to emit either long wave ultraviolet light, visible light, infrared light or a mixture thereof, although this may vary depending on the character of the material and the desired separating effect, providing illumination for the optimal operation of the sensor unit (FIG. 6). Following illumination the papers are carried past the sensor unit and a related valve array (not shown; discussed below) that carry out rejection/retention of papers.

FIG. 3 further shows only light papers 42 on the upper portion 16 of the transport belt, the light papers 42 and shaded papers 44 having been retained or rejected by the system. In this instance the lighter papers 42 continue over the top of the transport belt 2 and are received on/in another transporter/repository 22. In alternative embodiments, only the shaded papers 44 may selectively continue over the top of the transport belt 2.

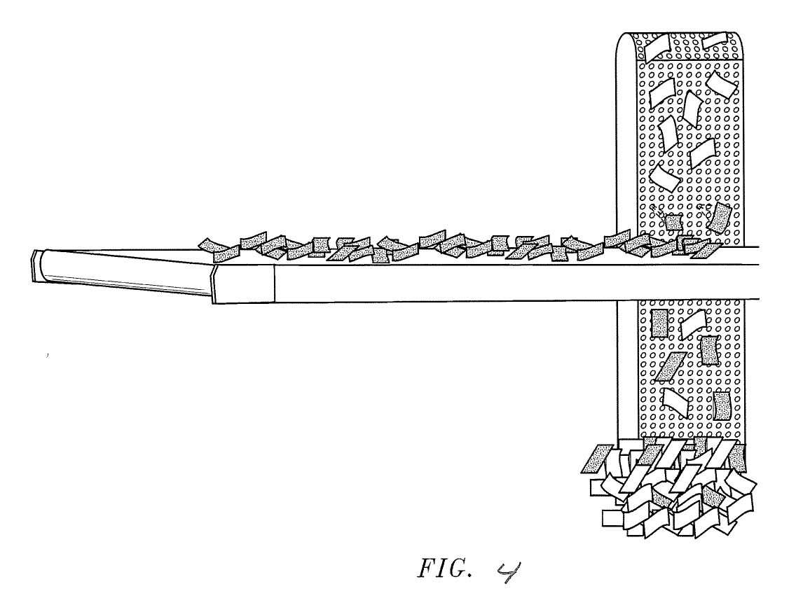

FIG. 4 shows another perspective on a paper handling system 400 in accordance with embodiments of the present invention. A substantially vertical transport belt 402 captures both light papers 404 and shaded papers 406 from a repository 408 of mixed papers. The system separates the light papers 404 from the shaded papers 406 by releasing or blowing (discussed in more detail below) the shaded papers 406 from the substantially vertical transport belt 402, such that they are received on a second transport belt 410 that carries the shaded papers for further processing.

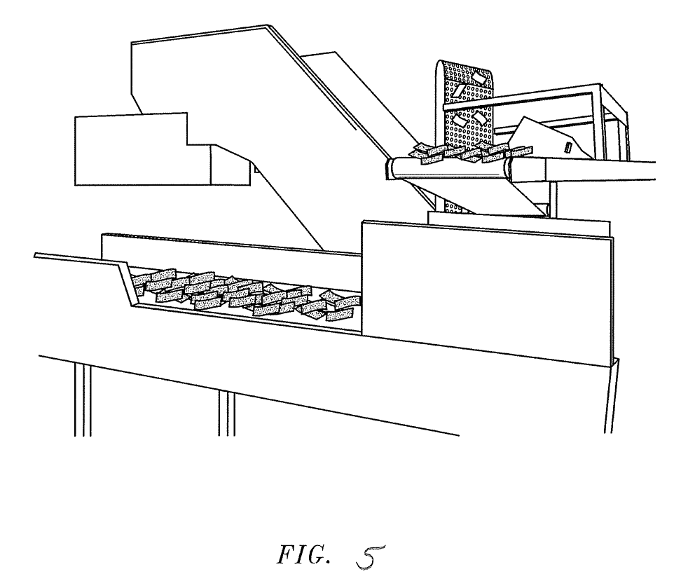

FIG. 5 illustrates yet another perspective on a paper handling system 500 in accordance with embodiments of the present invention. A tangent conveyor 501, operating in a direction substantially tangent to the transport belt 2, is present to capture the dislodged material, in this case shaded paper, and remove it to a to a further transporters 504 or to an additional storage area (not shown), although alternate removal schemes are possible. The rejected material continues up the belt 2 and over the top of the frame 6. In this area over the top of and behind the frame 6, the system may be configured such that the belt hole grid is not connected to the vacuum supply and the material falls off the belt 2 onto another conveyor belt 22 (FIG. 3) or similar arrangement set up for its removal. An idler belt (not show for clarity) may be used in some embodiments to aid the rejected material in following the one hundred eighty degree turn from the inspection area over the top of the frame 6.

Referring to FIG. 6, the sensor unit 1, along with the associated driver and control box 13, includes a wide-angle compound lens 7, adjustable both for relative magnification and focus. An adapter tube and lens fixing assembly 8 allows an image of the material flow to be presented to an integrated circuit sensor array (not specifically shown) located on a printed circuit card 9. The lens 7 is adjusted to present an image of the material on the belt 2 (FIGS. 3, 4 & 5) to the integrated circuit sensor array in such a manner as to achieve a proportional fit of the array to the lateral dimension of the material inspection area (not specifically shown). Such an image is also proportional, in the same ratio, to the distribution of valves in a valve array (not shown).

In some embodiments, the sensor unit is a one by sixty-four (64) pixel device, with integral electronics capable of generating an analog voltage relative to the illumination falling on each pixel. The sensor is sensitive to light of wavelengths above, thru and below the human visible range, enabling illumination of various wavelengths to be utilized based on the character of the material to be sorted and the desired results.

Upon receipt of a command signal, generated in synchronization with the motion of the belt, the integrated circuit sensor clocks out a sequence of analog values representing the illumination levels that existed at each pixel at the instant of the command. An integrated circuit microprocessor printed circuit card assembly 11 is connected to the sensor integrated circuit by a cable 10. The integrated circuit microprocessor is programmed with software, and is equipped with input capability, such that it can accept the packetized voltage levels produced by the sensor and compare them with an index value set by the machine operator at the driver and control box 13. This results in the generation of an array of binary values in memory internal to the microprocessor.

As the belt 2 continues to move upward, this process is repeated once per belt hole grid unit (not specifically shown). Successive one dimensional arrays are added to the first, such that a memory map is generated in the microprocessor that represents whether the material associated with that particular pixel location is either to be retained or rejected. In sequence, as each one dimensional array is clocked up sufficient times such that it now represents material that is physically positioned over the top of the valve array (not shown), that one dimensional array is transmitted to the driver and control box 13 by cable 12. An arrangement of integrated circuit microprocessors coupled with appropriate synchronization and power output circuitry located in the driver and control box 13 then activates the valve array. The individual binary values within each array that represent ‘retain’ or ‘reject’ decisions are amplified and fed to the valves within the valve array via cable 14.

In various embodiments, the valve array includes a manifold and a one dimensional array of electrically actuated pneumatic valves. In some embodiments, paper to be retained is freed from the belt. For example, where the operator has elected to reject material/paper, the valve is not actuated. In the case of material the operator has elected to retain, the valve is actuated by an electrical signal from the decoding and driver control box 13, such that the vacuum holding that individual piece of material to the belt 2 is neutralized, and the piece of material is blown free of the belt 2.

The above description of illustrated embodiments of the invention is not intended to be exhaustive or to limit the invention to the precise forms disclosed. While specific embodiments of, and examples for, the invention are described herein for illustrative purposes, various equivalent modifications including those described above are possible within the scope of the invention, as those skilled in the relevant art will recognize. The teachings provided herein of the invention can be applied to other learning systems, not necessarily the interactive systems described above. The various embodiments above can be combined to provide further embodiments. In general, in the following claims, the terms used should not be construed to limit the invention to the specific embodiments disclosed in the specification and the claims, but should be construed to include all interactive learning and training systems. Accordingly, the invention is not limited by the disclosure, but instead the scope of the invention is to be determined entirely by the following claims, which are to be construed in accordance with established doctrines of claim interpretation.

What is claimed is:

1. A method comprising:
illuminating paper moving on a substantially vertical transport belt;
sensing variations in reflectivity among the paper;
comparing the variations in reflectivity to pre-selected acceptable reflectivity values, thus determining locations of acceptable paper on the transport belt; and
rejecting paper based on the locations of acceptable paper.

2. The method of claim 1 further comprising generating a map depicting locations of paper on the transport belt, each location indicative of the reflectivity of the paper at the location.

3. The method of claim 2 wherein reflectivity indicates acceptability of paper, reflectivity of paper within a reflectivity spectrum, or combinations thereof.

4. The method of claim 1 wherein sensing is carried out with one or more pixel array sensing units.

5. The method of claim 3 wherein the one or more pixel array sensing units comprise a wide angle lens.

6. The method of claim 1 wherein illuminating comprises illuminating with long wave ultraviolet light, visible light, infrared light, or combinations thereof.

7. The method of claim 1 further comprising:
maintaining a vacuum created by a negative pressure on the posterior side of the transport belt to hold the paper to the anterior side of the transport belt;
wherein rejecting comprises neutralizing the vacuum by actuating a valve on the posterior side of the transport belt corresponding to the location of the rejected paper on the map, thus releasing the paper from the belt.

8. The method of claim 1 further comprising:
maintaining a vacuum created by a negative pressure on the posterior side of the transport belt to hold the paper to the anterior side of the transport belt;
wherein rejecting comprises counteracting the vacuum with compressed air in a location corresponding to the location of the rejected paper on the map, thus removing the rejected paper from the transport belt.

9. The method of claim 1 wherein rejecting is synchronized with the movement of paper on the transport belt and the map representing acceptable illumination levels.

10. The method of claim 1 further comprising leveling the paper on the transport belt.

11. The method of claim 1 wherein moving comprises from about 1 to about 2000 feet per minute.

12. The method of claim 1 wherein moving is in a substantially vertical plane.

13. The method of claim 1 wherein moving is through a bin containing an assortment of paper at the base of the transport belt whereby the paper is removeably affixed to the anterior side of the transport belt by a vacuum created by a negative pressure on the posterior side of the transport belt.

14. A paper handling method comprising:
creating a negative pressure on the posterior side of a transport belt, the transport belt moving in a substantially vertical plane;
passing the transport belt through a bin of paper, the paper removeably affixed to an anterior side of the transport belt by the negative pressure; and
selectively detaching the paper from the transport belt by selectively injecting air through perforations in the transport belt, the injected air overcoming the negative pressure.

15. A paper handling system comprising:
a continuous transport belt having perforations and moving in a substantially vertical plane;
an apparatus for creating a negative pressure on the posterior side of the transport belt;
a bin containing an assortment of paper at the base of the transport belt whereby the paper is removeably affixed to the anterior side of the transport belt by the negative pressure as the transport belt moves in a substantially vertical plane; and
an array of valves positioned on the posterior side of the transport belt for selectively injecting air through the perforations in the transport belt depending on variations in reflectivity among the paper thereby overcoming the negative pressure and causing the paper to detach from the transport belt.

16. The system of claim 15 further comprising a leveling arrangement for leveling materials on the transport belt.

17. The system of claim 15 further comprising an illumination source for illuminating the paper as it travels along the transport belt.

18. The system of claim 15 further comprising a sensor for detecting variations in reflectivity among the paper.

19. The system of claim 15 further comprising electronics for creating a map of the variations in illumination levels among the paper and for using the map to synchronize movement of paper on the transport belt with selectively injecting air through perforations causing selected paper to detach from the transport belt.

20. The system of claim 15 wherein the perforations comprise a uniform grid of holes in the transport belt.

21. The system of claim 15 wherein the perforations comprise a grid of holes having nominal hole spacing from about one (1) to about three (3) inches, each hole having a surface area from about three quarters to about two square inches (0.75-2 in²).
